(19) United States
(12) Patent Application Publication
(10) Pub. No.: US 2023/0419919 A1
(43) Pub. Date: Dec. 28, 2023

(54) METHOD FOR DRIVING LIQUID CRYSTAL DISPLAY REDUCING IC AREA COST OF A SOURCE DRIVER IC LAYOUT

(71) Applicant: NOVATEK MICROELECTRONICS CORP., HSINCHU (TW)

(72) Inventor: YEN-CHENG CHENG, HSINCHU CITY (TW)

(21) Appl. No.: 17/809,504

(22) Filed: Jun. 28, 2022

(51) Int. Cl. G09G 3/36

(52) U.S. Cl. CPC G09G 3/3688; G09G 3/3614; G09G 2310/0289; G09G 2310/0291; G09G 2310/027; G06F 3/0412

(57) ABSTRACT

A method for driving a liquid crystal display reducing IC area cost of a source driver IC layout is provided, in which a plurality of common voltage electrodes are configured in the display panel. The method includes the following steps of applying a first voltage to at least one of the common voltage electrodes in a first frame period and applying a second voltage to the at least one of the common voltage electrodes in a second frame period. The first and second voltage are different. The method is applicable to a source driver structure of the display panel, and by employing the method, a voltage level of a source driving signal of the source driver is controlled to be positive and only positive-voltage domain circuit is required in the layout configuration. As a result, the invention is effective in reducing IC area cost and avoiding redundant area waste.

### BACKGROUND OF THE INVENTION

### Field of the Invention

The present invention is related to an operation method for driving a display panel. More particularly, it is related to an operation method in which various common mode voltages can be supplied to a source driver in order to drive a liquid crystal display panel.

### Description of the Prior Art

As known, Liquid Crystal Display (LCD) panels are characterized by low power consumption, thin and light appearance as well as no radiation pollution. In addition, high contrast, high brightness, high color saturation, and wide viewing angle of the image shown by a LCD panel also makes the LCD panel become a mainstream in recent years, and thus has been widely used in a variety of computer systems, mobile phones, personal digital assistants (PDAs), information products, and so on.

Generally, LCD panels use a timing controller to generate data signals related to its displayed image, as well as control signals and clock signals required to drive the liquid crystal display panel. FIG. 1 shows a schematic diagram of a conventional liquid crystal display 10. The liquid crystal display 10 includes a liquid crystal display (LCD) panel 100, a timing controller 102, a source driver 104 and a gate driver 106. The liquid crystal display panel 100 is used to display a screen, which is composed of two substrates, and a liquid crystal material (LCD layer) is filled between the two substrates. The timing controller 102 is configured to generate a data signal related to the displayed image and a polarity control signal and a latch signal required to drive the liquid crystal display panel 100. FIG. 2 shows a detailed diagram of the components in FIG. 1. Please refer to FIG. 1 and FIG. 2 at the same time. As can be seen, the liquid crystal display panel 100 of the liquid crystal display 10 includes a plurality of pixels arranged in an array and is driven in accordance with the received gate scanning signals G1, G2 . . . to GN and the source driving signals S1, S2 . . . to SN. In the conventional liquid crystal display 10, the gate scanning signals G1, G2 . . . to GN are sequentially enabled (elevated to a high voltage level) in a frame period to sequentially turn on the thin film transistor of each column of pixels in the liquid crystal display panel 100. The source driving signals S1, S2 . . . to SN also correspond to the enabling states of the gate scanning signals G1, G2 . . . to GN and generate corresponding voltage values according to the grayscale values to be displayed. Each pixel of the liquid crystal display panel 100 is electrically coupled with a common mode voltage Vcom, which performs as a reference voltage compared to the source driving signals S1, S2 . . . to SN when turning on the pixel. In a conventional scheme for driving the liquid crystal display panel 100, the common mode voltage Vcom is essentially given and fixed at a certain DC level. Therefore, for ensuring properties of the liquid crystal material and avoiding polarization phenomenon of the liquid crystal material in the liquid crystal display panel 100, a polarity of an output voltage of the pixel applied for driving the liquid crystal display panel 100 is required to switch between a positive polarity (+) and a negative polarity (−). Please refer to FIG. 3A and FIG. 3B, which show a relative polarity of a conventional liquid crystal display panel in a Zigzag mode and in a normal mode, respectively. FIG. 4 shows a schematic diagram of a conventional structure of the source driver 104. As we can see from FIG. 3A, FIG. 3B and FIG. 4, it is obvious that the positive polarity (+) and the negative polarity (−) to be displayed mainly reply on the source driver 104 to provide a DC positive-value source driving signal, for example, 0V˜6V and a DC negative-value source driving signal, for example −6V˜0V. Therefore, both a positive-voltage domain circuit 41, including a positive level shifter 411, a positive digital-to-analog converter 412, a positive operational amplifier 413 and a positive switch 414, and a negative-voltage domain circuit 43, including a negative level shifter 431, a negative digital-to-analog converter 432, a negative operational amplifier 433 and a negative switch 434 must be designed. The conventional source driver thus has a severe area-consuming problem. Besides, it is also known that the complexity for designing a negative-voltage domain circuit is always higher, which also makes the conventional source driver structure much more complicated and require additional layout circuit to comply with. As a result, reductions in area and layout cost in a source driver structure so far are still challenging and to be expected in the existing technologies.

As a result, it, in view of all, should be apparent and obvious that there is indeed an urgent need for the professionals in the field for a novel and inventive methodology to be developed, so as to solve the above-mentioned issues, and to enhance the area reduction efficiency of a conventional source driver.

### SUMMARY OF THE INVENTION

In order to overcome the above-mentioned disadvantages, one major objective in accordance with the present invention is to provide a novel operation method for driving a display panel.

The proposed operation method is applicable to a source driver of a liquid crystal display panel, such that various common voltage electrodes configured in the liquid crystal display panel can be provided with various common mode voltages. In other words, the common mode voltage of each pixel unit in the liquid crystal display panel is no longer fixed at a certain DC voltage level, but at a first voltage in a first frame period and at a second voltage in a second frame period. The given first voltage and the given second voltage are determined as different voltage values.

In specific, according to one embodiment of the invention, a plurality of common voltage electrodes are configured in a display panel. The display panel, for instance, may be a liquid crystal display panel. The proposed method for driving a liquid crystal display reducing IC area cost of a source driver IC layout is applicable to each of the plurality of common voltage electrodes configured in the display panel, and the method includes the following steps: applying a first voltage to at least one of the common voltage electrodes in a first frame period; and applying a second voltage to the at least one of the common voltage electrodes in a second frame period. The first voltage is different from the second voltage.

In one embodiment of the invention, when the first voltage is greater than the second voltage, and the first voltage is applied to the common voltage electrode of the pixel unit, a polarity of an output voltage to drive the pixel unit is negative.

For example, when a voltage of the source driving signal is S1, the first voltage is V1, the second voltage is V2, the first voltage V1 is greater than the second voltage V2 (V1>V2) and V1 is applied, then a voltage level of the output voltage equals to (S1−V1<0), which shows the negative polarity (−).

On the other hand, according to an alternative embodiment of the invention, when the first voltage is greater than the second voltage, and the second voltage is applied to the common voltage electrode of the pixel unit, then a polarity of the output voltage to drive the pixel unit is positive.

For example, when a voltage of the source driving signal is S1, the first voltage is V1, the second voltage is V2, the first voltage V1 is greater than the second voltage V2 (V1>V2), and V2 is applied, then a voltage level of the output voltage equals to (S1−V2>0), which shows the positive polarity (+).

According to the invention, either the first voltage V1 or the second voltage V2, can be for instance, determined as a high voltage level of common mode voltage (VCOMH) or a low voltage level of common mode voltage (VCOML).

As a result, it is believed that by employing the disclosed method of the invention, a voltage level of a source driving signal of the source driver is maintained to be positive. And the source driver simply includes positive-voltage domain circuit. In one embodiment, the positive-voltage domain circuit, for instance, can be composed of a positive level shifter, a positive operational amplifier and a positive digital-to-analog converter electrically connected between the positive level shifter and the positive operational amplifier. However, the present invention is not limited thereto. As can be seen, by employing the disclosed technical solution of the present invention, conventional negative-voltage domain circuit, switching element for providing alternative polarity, and well isolation between a conventional positive and negative voltage domain circuit can all be omitted. Therefore, while compared to the prior arts, the invention is apparently effective in reducing IC area cost and avoiding redundant area waste of source driver IC layout configuration.

The prior severe area cost issues are believed to be eliminated in the present invention. Thereby, it is believed that the present invention achieves to successfully solves the problems of prior arts and performs as being highly competitive and able to be widely utilized in any related industries.

These and other objectives of the present invention will become obvious to those of ordinary skill in the art after reading the following detailed description of preferred embodiments.

It is to be understood that both the foregoing general description and the following detailed description are exemplary and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 shows a schematic diagram of a conventional liquid crystal display.

FIG. 2 shows a detailed diagram of the components in FIG. 1.

FIG. 3A shows a relative polarity of a conventional liquid crystal display panel in a Zigzag mode.

FIG. 3B shows a relative polarity of a conventional liquid crystal display panel in a normal mode.

FIG. 4 shows a schematic diagram of a conventional structure of a source driver.

FIG. 5 shows a diagram schematically illustrating a liquid crystal display (LCD) panel in accordance with an embodiment of the invention.

FIG. 6A show a schematic diagram of one pixel unit in FIG. 5 in a first frame period.

FIG. 6B show a schematic diagram of one pixel unit in FIG. 5 in a second frame period.

FIG. 7 shows a flow chart illustrating the operation method according to the embodiment in FIG. 6A and FIG. 6B of the invention.

FIG. 8 shows a diagram schematically illustrating a source driver and its output voltage applied for driving the pixel unit of the liquid crystal display panel according to the embodiment of the invention.

FIG. 9 shows a diagram schematically illustrating the source driver applied to an in-cell display structure integrated with a touch function and its output voltage applied for driving the pixel unit of the liquid crystal display panel according to one embodiment of the invention.

FIG. 10 schematically shows the polarity of the output voltage applied for driving the pixel unit of the liquid crystal display panel according to FIG. 9.

FIG. 11 shows a layout configuration of a traditional source driver structure.

FIG. 12 shows a modified layout configuration of an improved source driver structure according to the embodiment of the present invention.

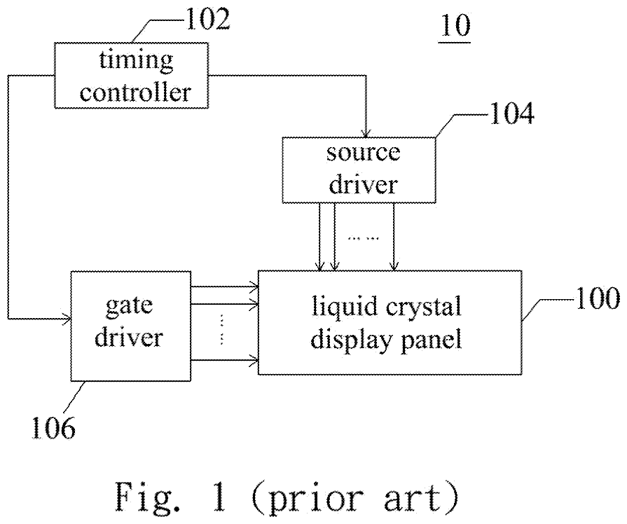

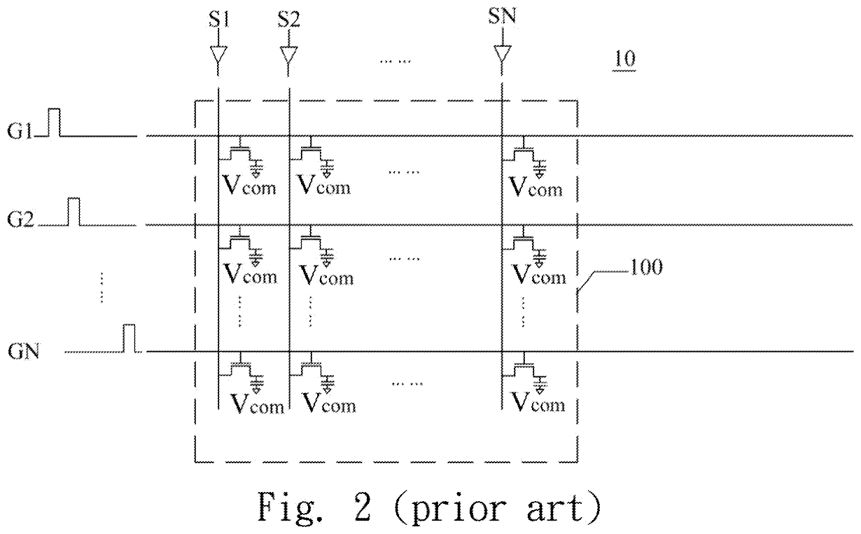

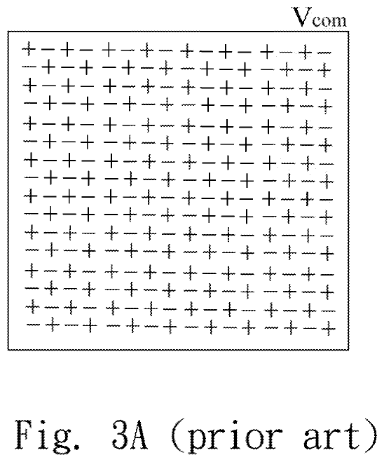

### DESCRIPTION OF THE PREFERRED EMBODIMENTS

Reference will now be made in detail to embodiments illustrated in the accompanying drawings. Wherever possible, the same reference numbers are used in the drawings and the description to refer to the same or like parts. In the drawings, the shape and thickness may be exaggerated for clarity and convenience. This description will be directed in particular to elements forming part of, or cooperating more directly with, methods and apparatus in accordance with the present disclosure. It is to be understood that elements not specifically shown or described may take various forms well known to those skilled in the art. Many alternatives and modifications will be apparent to those skilled in the art, once informed by the present disclosure.

Unless otherwise specified, some conditional sentences or words, such as “can”, “could”, “might”, or “may”, usually attempt to express that the embodiment in the invention has, but it can also be interpreted as a feature, element, or step that may not be needed. In other embodiments, these features, elements, or steps may not be required.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The phrases “be coupled to,” “couples to,” and “coupling to” are intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The invention is particularly described with the following examples which are only for instance. Those skilled in the art will readily observe that numerous modifications and alterations of the device and method may be made while retaining the teachings of the invention. Accordingly, the following disclosure should be construed as limited only by the metes and bounds of the appended claims. In the whole patent application and the claims, except for clearly described content, the meaning of the article “a” and “the” includes the meaning of “one or at least one” of the element or component. Moreover, in the whole patent application and the claims, except that the plurality can be excluded obviously according to the context, the singular articles also contain the description for the plurality of elements or components. In the entire specification and claims, unless the contents clearly specify the meaning of some terms, the meaning of the article “wherein” includes the meaning of the articles “wherein” and “whereon”. The meanings of every term used in the present claims and specification refer to a usual meaning known to one skilled in the art unless the meaning is additionally annotated. Some terms used to describe the invention will be discussed to guide practitioners about the invention. Every example in the present specification cannot limit the claimed scope of the invention.

In the following descriptions, an operation method for driving a display panel, for instance, a liquid crystal display panel, will be provided. The proposed operation method is applicable to a source driver structure of the display panel. According to one embodiment of the present invention, the source driver structure is a source driver of a liquid crystal display panel. By adopting the disclosed method, a voltage level of a source driving signal of the source driver is controlled to be positive and only positive-voltage domain circuit is required in the layout configuration. Therefore, the present invention is beneficial to reducing IC area cost of the source driver structure and avoiding redundant area waste.

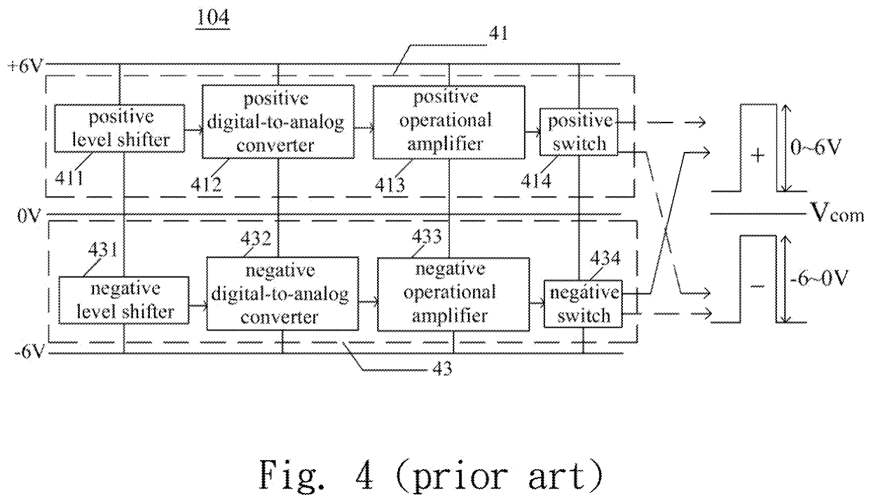

Please refer to FIG. 5, which shows a diagram schematically illustrating a liquid crystal display (LCD) panel in accordance with an embodiment of the invention. In the liquid crystal display panel 100A, a plurality of pixel units P1 are configured. Each of the pixel units P1 is correspondingly coupled to one common voltage electrode 10 and is driven by a gate scanning signal and a source driving signal. For example, the gate scanning signals G1, G2 . . . to GN are sequentially enabled (elevated to a high voltage level) in a frame period to sequentially turn on the thin film transistor of each column of the pixel units P1 in the liquid crystal display panel 100A. The source driving signals S1, S2 . . . to SN correspond to the enabling states of the gate scanning signals G1, G2 . . . to GN and generate corresponding voltage values according to the grayscale values to be displayed on the liquid crystal display panel 100A.

According to the invention, when the plurality of the gate scanning signals G1, G2 . . . to GN and the plurality of the source driving signals S1, S2 . . . to SN are sequentially applied to turn on the plurality of pixel units P1 in the liquid crystal display panel 100A, the plurality of pixel units P1 are able to switch from a first frame period to a second frame period for imaging.

In the following, the present invention is aimed to provide a method for driving a liquid crystal display reducing IC area cost of a source driver IC layout. For an illustrative embodiment to clearly describe the technical contents of the invention, one single pixel unit P1 will be taken as an example for explaining the disclosed operation method of the present invention. And yet, the disclosed operation method can be applied to each and every pixel unit P1 of the liquid crystal display panel 100A undoubtedly.

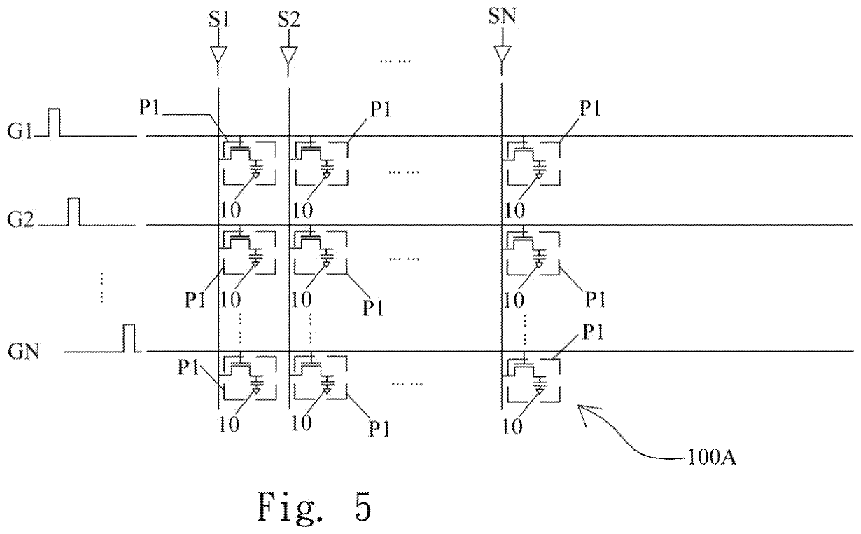

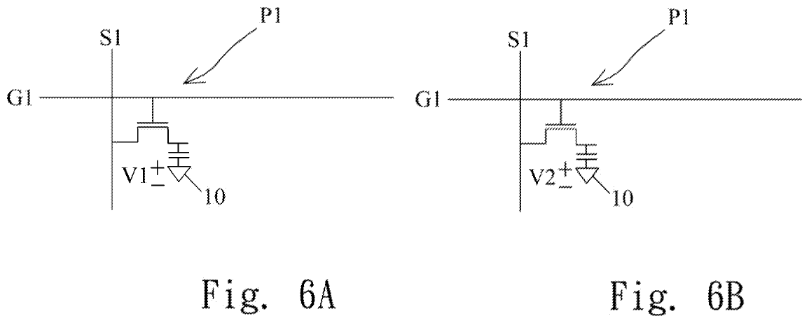

Please refer to FIG. 6A and FIG. 6B, which individually show a schematic diagram of one pixel unit P1 in FIG. 5 under different frame period. FIG. 7 shows a flow chart illustrating the operation method according to the embodiment in FIG. 6A and FIG. 6B of the invention. With referring to FIG. 6A, FIG. 6B and FIG. 7, the proposed operation method for driving the liquid crystal display panel 100A is introduced as follows. As described earlier, each pixel unit P1 is correspondingly coupled to one common voltage electrode 10. And a plurality of common voltage electrodes 10 are configured in the liquid crystal display panel 100A. The disclosed operation method includes the step S702 of applying a first voltage V1 to the common voltage electrode 10 in a first frame period, and the step S704 of applying a second voltage V2 to the common voltage electrode 10 in a second frame period. According to the invention, the first voltage V1 is different from the second voltage V2.

In one embodiment, when the first voltage V1 is greater than the second voltage V2, the first voltage V1 is defined as a high voltage level of common mode voltage (VCOMH) while the second voltage V2 is defined as a low voltage level of common mode voltage (VCOML).

On the contrary, in an alternative embodiment when the second voltage V2 is greater than the first voltage V1, then the second voltage V2 is defined as a high voltage level of common mode voltage (VCOMH) while the first voltage V1 is defined as a low voltage level of common mode voltage (VCOML).

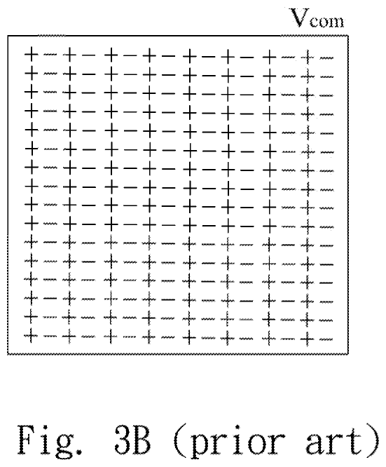

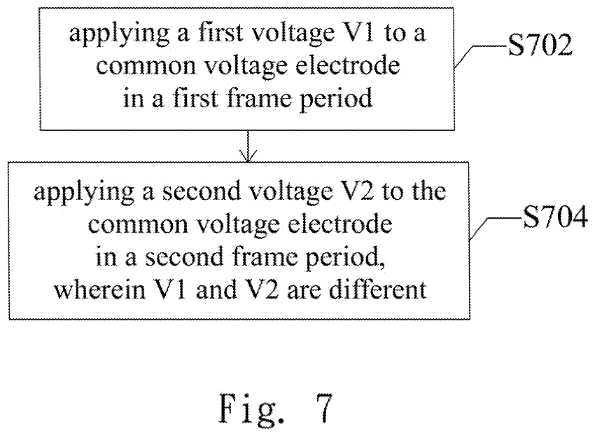

Please refer to FIG. 8, which shows a diagram schematically illustrating a source driver 104A and the output voltage applied for driving the pixel unit P1 of the liquid crystal display panel 100A according to the embodiment of the invention. As illustrated, the proposed operation method disclosed in FIG. 7 is applicable to the source driver 104A, wherein the source driver 104A is simply composed of a pair of positive-voltage domain circuit 41A, and each positive-voltage domain circuit 41A includes a positive level shifter (P-LVSHT) 1041, a positive digital-to-analog converter (P-DAC) 1042 and a positive operational amplifier (P-OP) 1043. While compared to the prior art as shown in FIG. 4, it is apparent that by employing the invention, conventional switch configuration is omitted. In addition, according to the invention, since the common voltage electrode 10 is given and supplied with different voltage in different frame period, indicating that the common mode voltage is no longer fixed at a certain voltage level, but at a first voltage V1 in a first frame period and at a second voltage V2 in a second frame period, the present invention achieves to control a voltage level of the source driving signal of the source driver 104A to be positive, for example, 0˜6V as illustrated in FIG. 8. As a result, according to the embodiment of the present invention, only positive-voltage domain circuit 41A is used in the source driver 104A. The conventional negative-voltage domain circuit is omitted as well. Therefore, it is believed that the area consuming problem existing in the prior arts is effectively solved.

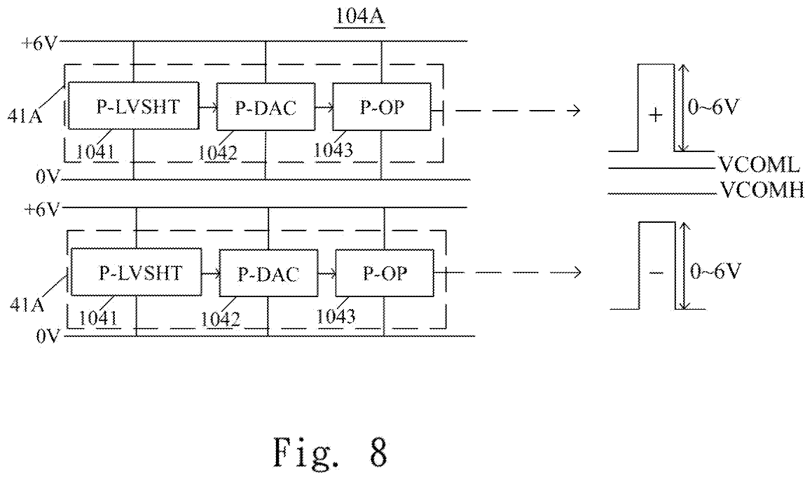

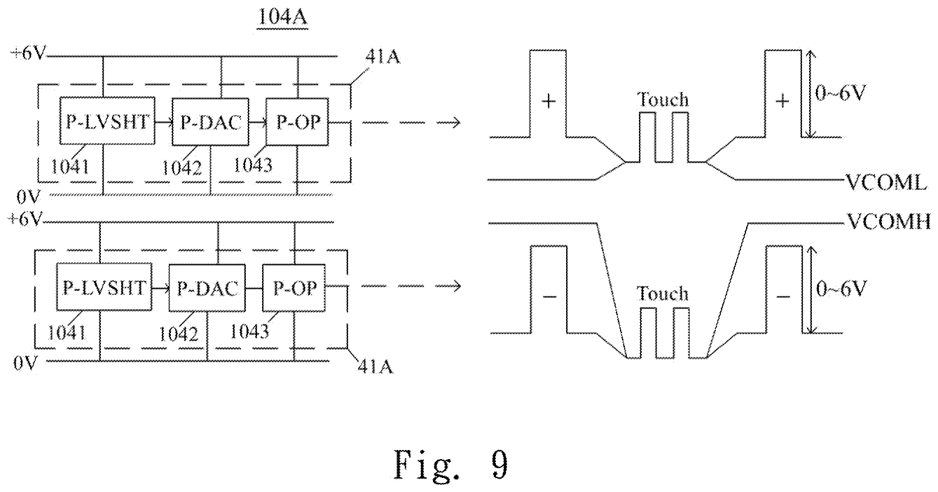

Furthermore, please refer to FIG. 9, which shows a diagram schematically illustrating the source driver 104A applied to an in-cell display structure integrated with a touch function and its output voltage applied for driving a pixel unit of the liquid crystal display panel according to one embodiment of the invention. FIG. 10 schematically shows the polarity of the output voltage applied for driving the pixel unit of the liquid crystal display panel according to FIG. 9. As we can see from FIG. 9 and FIG. 10, the in-cell liquid crystal display panel 100B includes a plurality of sensing pads 111 served as the common voltage electrodes in a display period of a frame. The common mode voltage is not fixed at a certain voltage level like it was in the prior art, but is modified to be at a first voltage (for instance, the low voltage level of common mode voltage VCOML) in a first frame period and at a second voltage (for instance, the high voltage level of common mode voltage VCOMH) in a second frame period. In one embodiment, when the first voltage is greater than the second voltage, and the first voltage is applied to the common voltage electrode of the pixel unit, a polarity of the output voltage to drive the pixel unit is negative (−). For example, when a voltage of the source driving signal is S1 (S1=3V) and the first voltage is V1 (V1=6V), then a voltage level of the output voltage equals to (S1−V1=“3V”−“6V”=“−3V”<0), which shows the negative polarity (−).

In another embodiment, when the first voltage is greater than the second voltage, and the second voltage is applied to the common voltage electrode of the pixel unit, then a polarity of the output voltage to drive the pixel unit turns to be positive (+). For example, when a voltage of the source driving signal is S1 (S1=3V) and the second voltage is V2 (V2=0V), then a voltage level of the output voltage equals to (S1−V2=“3V”−“0V”=“3V”>0), which shows the positive polarity (+).

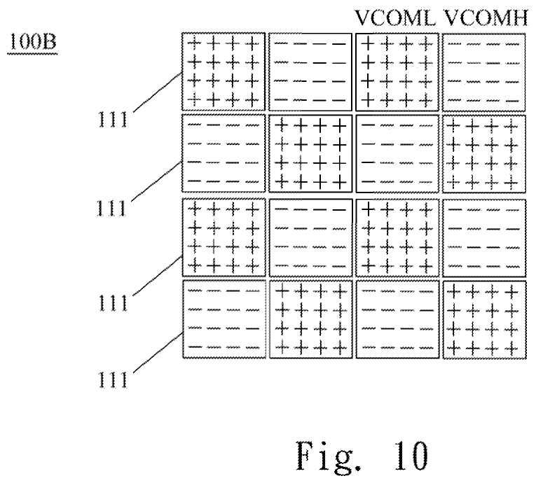

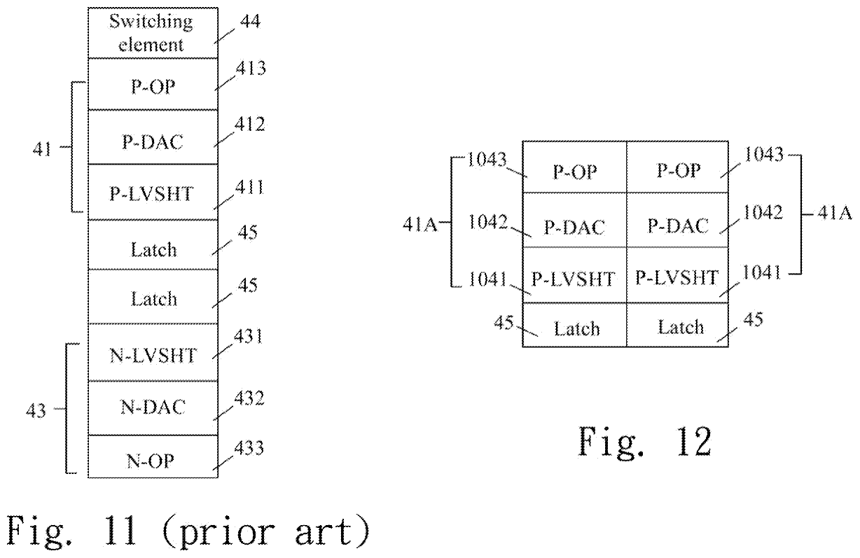

Moreover, FIG. 11 shows a layout configuration of a traditional source driver structure. As illustrated, it is required to design both a positive-voltage domain circuit 41 and a negative-voltage domain circuit 43. The positive-voltage domain circuit 41 includes a positive level shifter (P-LVSHT) 411, a positive digital-to-analog converter (P-DAC) 412 and a positive operational amplifier (P-OP) 413. The negative-voltage domain circuit 43 includes a negative level shifter (N-LVSHT) 431, a negative digital-to-analog converter (N-DAC) 432 and a negative operational amplifier (N-OP) 433. Latches 45 are configured between the positive-voltage domain circuit 41 and the negative-voltage domain circuit 43. In order to provide alternative polarity, a switching element 44 is also necessary. In general, a typical length or width of a negative level shifter is approximately 30 μm, which consumes a great amount area of the traditional source driver structure. On the contrary, please refer to FIG. 12, which shows a modified layout configuration of an improved source driver structure according to the embodiment of the present invention. It is apparent that only positive-voltage domain circuits 41A are required. And each positive-voltage domain circuit 41A includes a positive level shifter (P-LVSHT) 1041, a positive digital-to-analog converter (P-DAC) 1042 and a positive operational amplifier (P-OP) 1043. Conventional negative-voltage domain circuits as well as switching elements are omitted. Since a typical length or width of a positive level shifter is merely about 10 μm, which is much less than a typical length or width of a negative level shifter, the modified layout configuration of the invention achieves to have an optimized minimum cell pitch and consumes less area than the traditional scheme. In addition, since only positive-voltage domain circuits are designed in the modified layout and there is no longer negative-voltage domain circuit needed, conventional isolation disposed between the positive-voltage domain circuit and the negative-voltage domain circuit, for example a well isolation, can be omitted as well. The present invention is thus achieving to greatly reduce the layout area of a source driver structure and avoid redundant area waste.

Therefore, according to the present invention, the foregoing operation method is proposed to be applied to a liquid crystal display panel, such that a plurality of common voltage electrodes configured in the liquid crystal display panel can be provided with various common mode voltages. Based on at least one embodiment provided above, it is believed that the proposed operation method for driving the liquid crystal display panel of the present invention is characterized by providing an adjustable common mode voltage, for instance a high voltage level of common mode voltage VCOMH or a low voltage level of common mode voltage VCOML to various common voltage electrode of the pixel units in the liquid crystal display panel. As a result, various pixel unit can be driven by an adequate common mode voltage as required and provides alternative polarity merely adopting a positive voltage level of a source driving signal. And thus, while compared to the prior arts, only positive-voltage domain circuit is needed. And by employing the proposed scheme, the present invention is thus believed as beneficial to reducing area cost of a typical source driver IC.

On account of the above, it is obvious that the present invention, when compared to the existing technologies, apparently shows much more effective performances than before. In addition, it is believed that the present invention is instinct, effective and highly competitive for IC technology and industries in the market nowadays, whereby having extraordinary availability and competitiveness for future industrial developments and being in condition for early allowance.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

1. A method for driving a liquid crystal display reducing IC area cost of a source driver IC layout, wherein a plurality of common voltage electrodes are disposed in a display panel, the method comprising:
applying a first voltage to a first group of the plurality of common voltage electrodes; and
applying a second voltage to a second group of the plurality of common voltage electrodes;
wherein the first voltage and the second voltage are respectively applied to the first group of the plurality of common voltage electrodes and to the second group of the plurality of common voltage electrodes simultaneously; and
wherein the first voltage and the second voltage are greater than or equal to a zero voltage, and the first voltage is different from the second voltage.

2. The method according to claim 1, wherein a plurality of pixel units are disposed in the display panel, each of the plurality of pixel units is correspondingly coupled to one of the plurality of common voltage electrodes and is driven by a gate scanning signal and a source driving signal.

3. The method according to claim 2, wherein when the first voltage is greater than the second voltage, and the first voltage is applied to a common voltage electrode of a pixel unit, a polarity of an output voltage to drive the pixel unit is negative.

4. The method according to claim 3, wherein a voltage level of the output voltage is equal to (S1−V1), wherein where S1 is a voltage of the source driving signal and V1 is the first voltage.

5. The method according to claim 2, wherein when the first voltage is greater than the second voltage, and the second voltage is applied to a common voltage electrode of a pixel unit, a polarity of an output voltage to drive the pixel unit is positive.

6. The method according to claim 5, wherein a voltage level of the output voltage is equal to (S1−V2), wherein where S1 is a voltage of the source driving signal and V2 is the second voltage.

7. The method according to claim 2, wherein when a plurality of the gate scanning signals and a plurality of the source driving signals are sequentially applied to turn on the plurality of pixel units, the plurality of pixel units are able to switch from a first frame period to a second frame period for imaging.

8. The method according to claim 2, wherein a voltage level of the source driving signal is maintained to be positive.

9. The method according to claim 1, wherein the display panel includes a plurality of sensing pads serving as the common voltage electrodes in a display period of a frame.

10. The method according to claim 1, wherein the display panel includes a source driver, and the source driver comprises at least one positive-voltage domain circuit, which includes a positive level shifter, a positive operational amplifier and a positive digital-to-analog converter electrically connected between the positive level shifter and the positive operational amplifier.

11. The method according to claim 10, wherein a voltage level of a source driving signal of the source driver is maintained to be positive.
